(19) United States
(12) Patent Application Publication
(10) Pub. No.: US 2016/0321124 A1
(43) Pub. Date: Nov. 3, 2016

(54) REQUEST PROCESSING SYSTEM THAT MAPS ERRORS TO CORRESPONDING DATA SOURCES

(71) Applicant: QSI Management, LLC, Irvine, CA (US)

(72) Inventors: David Baker, Evans, GA (US); William Parrish, Decatur, GA (US)

(21) Appl. No.: 14/700,523

(22) Filed: Apr. 30, 2015

(51) Int. Cl. G06F 11/07

(52) U.S. Cl. CPC G06F 11/079; G06F 11/0745; G06F 11/0751

(57) ABSTRACT

Systems and methods are disclosed that enable errors to be mapped to data sources during request processing. Source data associated with a request is received by a client application and sent to a request processing application. A mapper module maps the source data from the client application to a standard format to form mapped data that can be processed by the request processing application. In response to an error during the mapping or processing of the request, data elements of the mapped data associated with the error are identified. The mappings are used to identify data elements of the source data associated with the error and generate error information sent back to the client application. The error information is displayed to a user and used by the client application to allow the user to modify the original source data elements associated with the error.

### BACKGROUND OF THE INVENTION

Embodiments of the present disclosure generally relate to computer processes for mapping data to specified standards or conventions, and for performing or facilitating error correction in connection with such data mappings.

Government legislated data standards are used for many different types of transactions. For example, data associated with requests for payment between banking institutions must typically adhere to a particular legislated standard. This prevents the confusion that may arise when payers and/or payees use different non-standard formats. Similarly, health care providers (e.g., a doctor) may submit data requesting a payment from a health insurance provider for medical services. In order to be processed by the health insurance provider, the data received from the providers typically must adhere to a specified standard format. For example, the X12 standard is currently used by health insurance providers and other payers for processing claims and payment requests.

However, these standards are often complex, and many entities that make requests (e.g., medical office staff members) may not be familiar with them. When there are errors associated with received requests, it may often be difficult for requesting entities to determine the nature of the error or how it can be corrected, due to unfamiliarity with the data standards.

In addition, legislative changes may cause the formats of these standards to change over time, necessitating upgrades of the applications used to process received requests. These changes may also require frequent updating of client applications, which may be tedious and time-consuming.

### SUMMARY

In many industries, in order for transaction requests, such as requests for payments, to be processed, the data associated with the request must be in a standard format. However, as the standards may often change, many client applications may not be configured to use the standard format, or may be configured to use older, out-of-date versions of the standard.

In some embodiments, a user (e.g., a medical service provider) inputs data associated with a request (e.g., a claim or payment request for medical services) into a user interface generated by a client application to be sent to a request processing module maintained by a payer or intermediary (e.g., a health insurance provider).

However, before the data is processed, it is first sent to a mapper module provided between the client application and the request processing module, which maps the source data received from the client application to the standard format, forming mapped data which may then be processed by the request processing module.

Thus, the client application does not need to be aware of the standard used by the request processing module. This makes it so that the client application does not need to be updated as the standard changes, so long as the actual raw data elements required remain the same. Instead, only the mapping module and the request processing application need to be updated to reflected changed standards.

If an error occurs during mapping or processing of the request, one or more data elements of the mapped data associated with the error may be identified. The mappings may then be used to identify which particular data elements of the original source data entered by the user that are associated with the error. This error information may be sent back to and displayed to the user by the client application. In addition, the error information may be used by the client application to allow the user to modify the original source data elements associated with the error. For instance, in response to the user clicking on a returned error message, the user may be presented with an interface that enables the user to input or edit data corresponding to the data elements associated with the error.

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 illustrates a block diagram illustrating an example request processing and error correction system in accordance with some embodiments.

FIG. 2A illustrates a block diagram of a client application in accordance with some embodiments.

FIG. 2B illustrates a block diagram of a mapper module in accordance with some embodiments.

FIG. 3 illustrates a flowchart of a process for processing requests and performing error correction, in accordance with some embodiments.

FIG. 4 illustrates a table showing a mapping between received data and the X12 standard in accordance with some embodiments.

FIG. 5 illustrates an interface at a client application containing a table showing one or more errors returned by the request processing application.

FIG. 6 illustrates an interface that may be displayed to a user in response to the user clicking on a hyperlink associated with a particular error.

### DETAILED DESCRIPTION OF THE PREFERRED EMBODIMENTS

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Although the present disclosure will refer primarily to healthcare and requested payments for medical services for purpose of example, the methods and systems described herein may be applied to any type of transaction requests that make use of data standards or conventions.

Specific embodiments and features will now be described in the context of a computer system that processes requests, such as medical service payment requests, received from client applications. In some embodiments, a user (e.g., a medical service provider) inputs data associated with a request (e.g., a claim or payment request for medical services) into a user interface generated by a client application to be sent to a request processing application maintained by a payer or intermediary (e.g., a health insurance provider). In order for the request to be processed, it must be in a standard format (e.g., the X12 standard). However, many client applications may not be configured to use the standard format, or may be configured to use older, out-of-date versions of the standard. Thus, before the data is processed, it is first sent to a mapper module, which maps the data from the client application to the standard format, forming mapped data which may then be processed.

By providing a mapper module between the client application and the request processing module, the client application does not need to be aware of the standard used by the request processing module. For example, the client application does not need to be updated as the standard changes, so long as the actual raw data elements required remain the same. Instead, only the mapping module and the request processing application need to be updated to reflected changed standards.

When errors occur during mapping or processing of the request, data elements of the mapped data associated with the error may be identified. The mappings may then be used to identify the particular data elements of the original data entered by the user that are associated with the error. This error information may be sent back to and displayed by the client application. In addition, the error information may be used by the client application to allow the user to modify the original data elements associated with the error. For instance, in response to the user clicking on a returned error message, the user may be presented with an interface that enables the user to input or edit data corresponding to the data elements associated with the error.

For example, a user (e.g., a medical office staff member) may use a client application to enter source data associated with a request for payment to an insurance company. The source data may include patient information, provider information, medical services rendered, requested payment amount, etc. Although the data must be in a certain standard format (e.g., the X12 standard) in order to be processed by the insurance company, the user does not need to be familiar with the X12 standard, or even be aware of its existence. In addition, the source data at the client application may be in a format different from the X12 standard, or an older out-of-date version of the X12 standard.

Once the user has finished entering the data, the source data is sent to a request processing application associated the insurance company. The source data is mapped to the X12 standard, so that it can be processed. If any errors occur during the mapping or processing of the request, the specific data elements of the source data associated with the error may be identified and used to generate error information which is sent back to the client application to be displayed to the user. For example, if the user entered a patient name and a patient policy number that does not match the records kept by the insurance company, an error notice may be displayed to the user that identifies the patient name and patient policy number data elements. The user may click on the displayed error notice to launch a user interface where the user can edit or re-enter the patient name and policy number data elements, which may then be resent to the insurance company for processing.

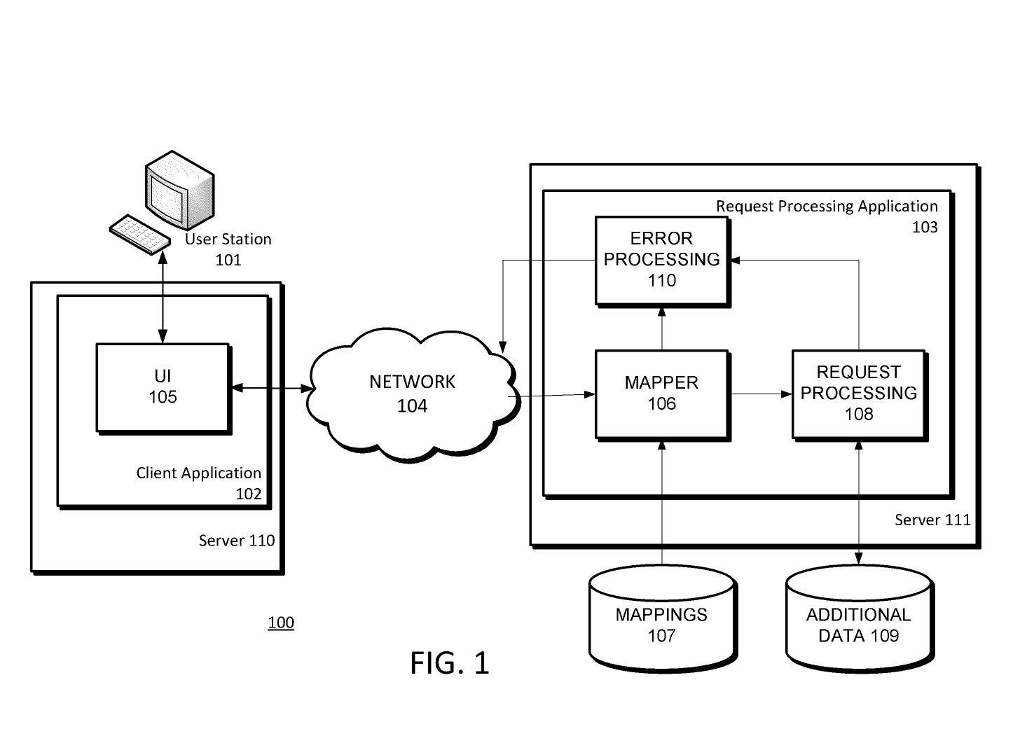

FIG. 1 illustrates a block diagram illustrating an example request processing and error correction system 100 in accordance with some embodiments. As shown in the embodiment of FIG. 1, the system 100 includes user stations 101 (one shown), a client application 102 that typically runs on a separate server or server system (e.g., server 110), and a request processing application 103 that runs on another server system (e.g., server 111). System 100 may also contain one or more databases or data stores (e.g., mappings data 107 and/or additional data 109) accessible by the request processing application 103.

The user station 101 may be any type of computing device or system that may be used to operate or interface with the applications in the system (e.g., client application 102). Examples of such user stations include, for example, workstations, personal computers, and remote computing terminals. User stations may also include mobile devices, such as smartphones, tablets, or touchscreen devices. The user station 101 comprises a display device, such as a display monitor, for displaying a user interface to users at the user station. The user station 101 may also comprise one or more input devices for the user to provide operational control over the activities of the system, such as a mouse, keyboard, or touchscreen to manipulate a graphical user interface to generate user inputs (e.g., by manipulating a cursor or pointing object in the graphical user interface). Typically, the user station 101 resides at a medical service provider's office and is operated by office staff

Client application 102 comprises one or more software applications accessible to a user at user station 101. Client application 102 may include a user interface (UI) 105 that can be operated on by a user on a user station 101 in order to input or manipulate data associated with requested transactions. In some embodiments, client application 102 may be implemented as part of the same computing system as user station 101, while in other embodiments, client application 102 may run on a separate computing system (e.g., on an application server). For example, the client application may be a web-based application that is accessed over a network via a browser running on the user station 101.

Client application 102 is configured to send and receive data associated with requested transactions with request processing application 103. In some embodiments, client application 102 may communicate with request processing application 103 through a network 104, while in other embodiments, client application 102 may communicate with request processing application 103 directly.

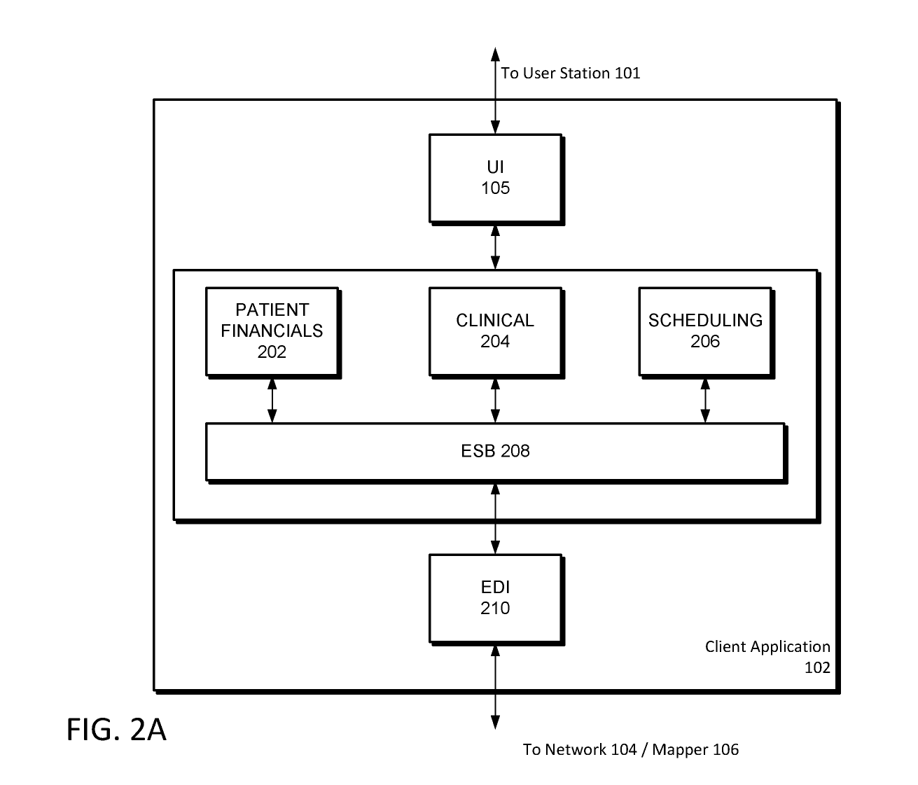

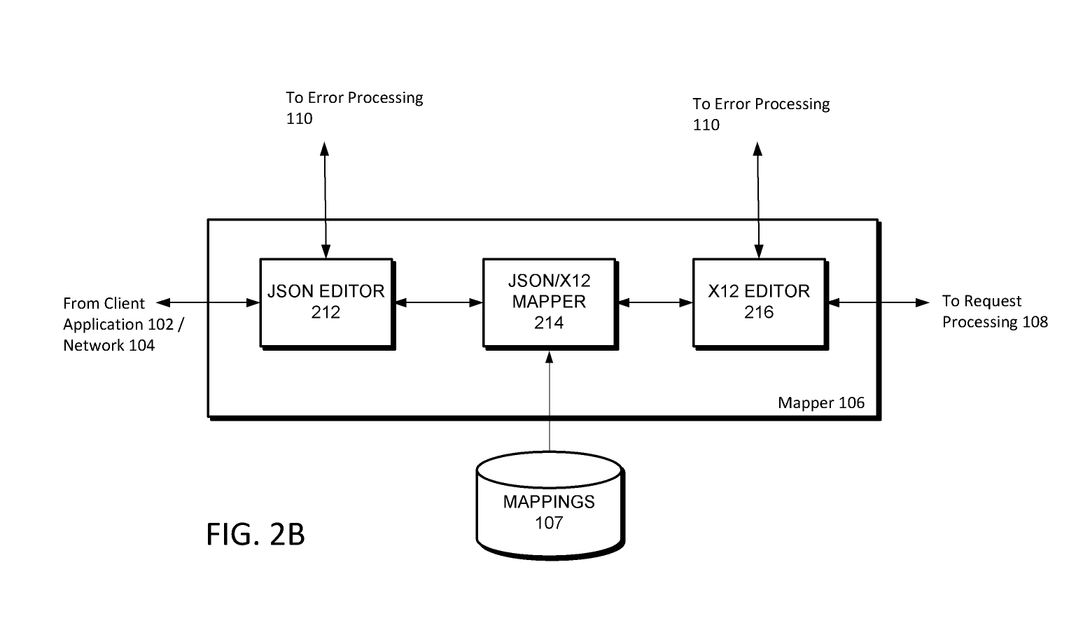

FIG. 2A illustrates a block diagram of a client application 102 in accordance with some embodiments, such as client application 102 as illustrated in FIG. 1. In accordance with the illustrated embodiment, a user at a user station 101 interacts with one or more UIs 105 generated by client application 102 to input and/or manipulate one or more different types of data. For example, the data may include patient financial data 202, clinical data 204 (e.g., pharmacy benefits associated with a patient), scheduling data 206, and/or other types of data. In some embodiments, different categories of data may represent different, independent domains and/or different software applications or modules. An ESB (enterprise serial bus) 208 may be used to implement communication between the various applications and/or modules in client application 102.

In some embodiments, the data generated by the various applications/modules is formatted as a JSON (JavaScript Object Notation) to facilitate communications between the different domains. In some embodiments, client application 102 also comprises an EDI (electronic data interchange) component 210 to communicate with request processing application 103 (e.g., over network 104) and/or other applications or modules.

Returning to FIG. 1, the request processing application 103 comprises one or more software applications that can be used to receive and process requests from client applications 102. Request processing application 103 may comprise a mapper or mapping module 106, a request processing module 108, and an error processing module 110. In addition to receiving data from client application 102, request processing application 103 may also access one or more additional databases or data stores for additional information. For example, mapper 106 may be configured to access mappings data 107, while request processing module 108 may be configured to access additional data 109.

In some embodiments, mapper 106 is configured to receive data from the client application 102, and map the received data to adhere to a standard format or convention. The standard format used may be specified by a government or regulatory agency, based upon the type of requested transaction. For example, for requested transactions relating to payments for medical services rendered, the X12 standard format may be used. For other types of transactions, different standard formats may be used.

In some embodiments, mapper 106, prior to mapping the received data to the standard format, may first perform one or more validations or checks on the received data. This may comprise checking that the received data contains one or more required data elements. Different types of requests may require different data elements to be present in the received data. For example, a request corresponding to a professional claim may require a “diagnosis code” data element to be present. If the received data does not contain a “diagnosis code” data element, then an error may be returned and the data is not mapped.

In some embodiments, after the received data has been mapped to the standard, mapper 106 may check the mapped data for formatting, syntax, and/or typographical errors before sending the mapped data to be processed by the request processing module 108. For example, the X12 standard requires certain data elements to adhere to a certain format or syntax. If a particular data element does not adhere to the required format (e.g., a “birthday” data element is not in the format of a date, or a “social security number” data element with an incorrect number of digits), an error may be returned. In some embodiments, the checks and/or validations described above may be performed at least in part by error processing module 110 (described in greater detail below).

FIG. 2B illustrates a block diagram of a mapper 106 in accordance with some embodiments, such as the mapper 106 illustrated in FIG. 1. In some embodiments, data sent from client application 102 to mapper 106 is in the JSON format, and is first received by a JSON editor 212. JSON editor 212 may first check the received data for errors (e.g., by determining if all required data elements are present), before sending the data to a JSON/X12 mapper 214.

JSON/X12 mapper 214 maps the data elements of the JSON data to X12 data elements to produce mapped data. In addition, the JSON/X12 mapper 214 may perform one or more formatting functions on the data (e.g., formatting date or time stamps, removing special characters from a data element, and/or the like). The mapped data may then be sent to an X12 editor 216, where further validations or checks may be performed. After the mapped data has been validated by X12 editor 216, it is sent to request processing module 108 for processing.

Request processing module 108 is configured to receive the mapped data that has been formatted in the standard format (e.g., X12 standard), and to process the request associated with the mapped data. For example, if the requested transaction corresponds to a payment for medical services rendered, request processing module 108 may validate the received mapped data (e.g., verify that the mapped data meets certain requirements; validate data elements of the mapped data, such as patient and/or provider information, against previously recorded data such as patient or provider records; etc.) and process the requested payment upon successful validation. In some embodiments, validation may be performed by retrieving additional data 109 to be compared with the received mapped data.

Error processing module 110 is used to detect and/or process errors in the mapped data. In some embodiments, error processing module 110 may perform various verifications, such as verifying that the source data contains all required data elements and/or verifying that the mapped data does not contain formatting or typographical errors prior to the mapped data being received by request processing module 108. In some embodiments, error processing module 110 may receive the results of such verifications from another module (e.g., from mapper 106). Additionally, error processing module 110 may be configured to validate the mapped data (e.g., as described above) or receive results of a validation performed on the mapped data from another module (e.g., request processing module 108).

When an error is detected, error processing module 110 is configured to generate error information, which is then sent back to client application 102. In some scenarios, an error will be associated with one or more data elements of the mapped data. For example, a data element of the mapped data may be in an incorrect format (e.g., a social security number data element with more than nine numerical digits), or may not pass one or more validations or checks (e.g., the first and last name data elements do not match the social security number data element according to previously stored patient records). The mappings may then be used to determine which data element or elements of the source data is/are associated with the error. The identified source data elements may then be used to form the error information to be sent to the client application 102, where a user at user station 101 may make appropriate corrections or input revised data using UI 105.

The data stored in additional data 109 may include a variety of information and data, such as personal information, medical information, financial information, and/or account information, among others. For example, the additional data may be related to patient account records stored by a healthcare institution (e.g., a health insurance agency). In such a case, the data may include patient personal information, information relating to a primary provider used by the patient, payment history, a history of medical services rendered on the patient, and/or the like.

The databases or data stores of system 100 (e.g., mappings 107 and/or additional data 109) may include a Relational Database Management System (RDBMS) that stores the data as rows in relational tables. The term “database,” as used herein, may refer to an database (e.g., RDBMS or SQL database), or may refer to any other data structure, such as, for example a comma separated values (CSV), extensible markup language (XML), text (TXT) file, flat file, spreadsheet file, and/or any other widely used or proprietary format. While the mappings 107 and additional data 109 are shown as distinct databases, in some embodiments they may operate on the same server computing system as the request processing application 103. In some embodiments, mappings 107 and/or additional data 109 may correspond to multiple databases, and/or span multiple servers or computing devices. In some embodiments, mappings 107 and/or additional data 109 are locally available to request processing application 103, while in other embodiments may be accessed through a network (e.g., network 104).

Although FIG. 1 illustrates a single user station 101 in communication with a single client application 102, in some embodiments, multiple user stations 101 may be used to access a client application 102. In addition, multiple client applications 102 may access a request processing application 103 through network 104. For example, a client entity (e.g., healthcare provider such as a hospital) may have multiple user stations 101 where a user may interact with a single client application. Multiple client entities, each having their own client application 102, may use their respective client applications to interact with a request processing application 103 (e.g., to request payments from a health insurance provider).

In some embodiments, the multiple client applications may transmit data to the request processing application 103 using different formats. In order to accommodate the different formats, mapper 106 may maintain multiple editors 212 and mappers 214 that access different sets of mappings 107 that map the different formats to the standard.

In addition, in some embodiments a single client application 102 may be in communication with multiple request processing applications 103. For example, a hospital maintaining a particular client application 102 may serve patients using a plurality of different insurance providers, each of which may have their own request processing application 103.

While the user station 101, client application 102, and request processing application 103 are shown as residing in distinct computing systems, in some embodiments, the user station 101, client application 102, and request processing application 103 may be part of the same computing system and/or organized differently than shown.

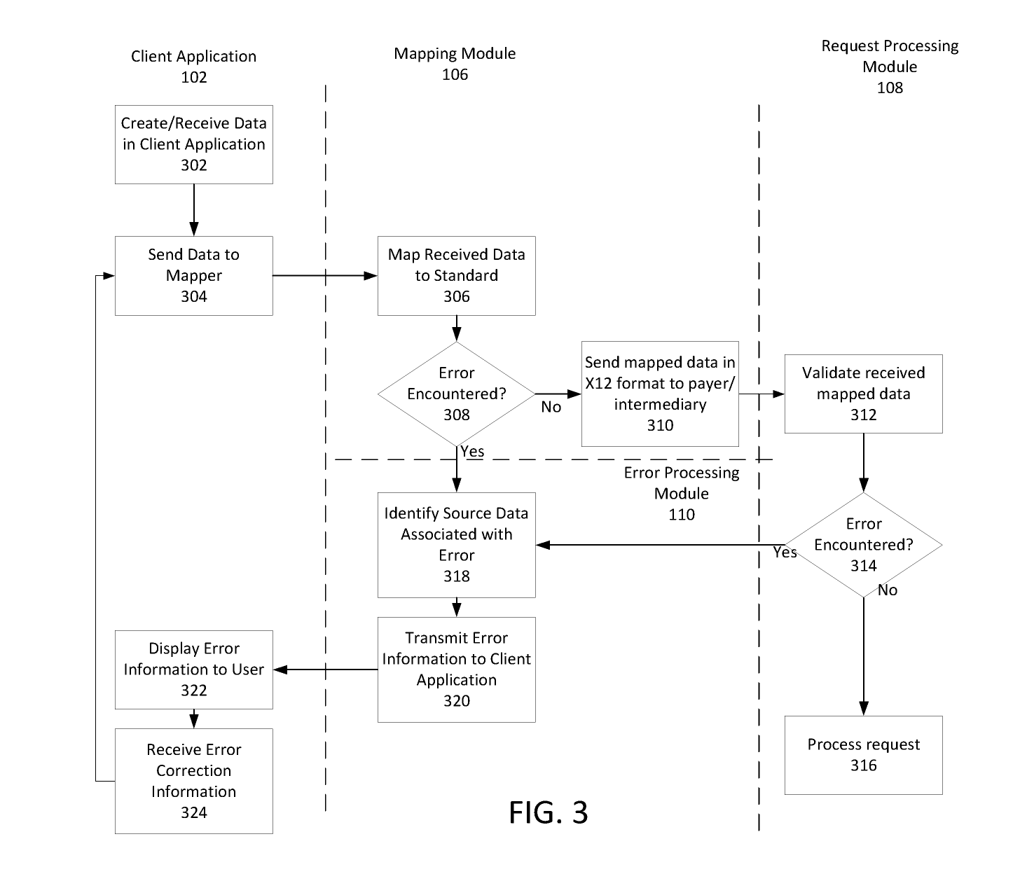

FIG. 3 illustrates a flowchart of a process for processing requests and performing error correction, in accordance with some embodiments. The process may be performed by a system such as that illustrated in FIG. 1. At 302, a client application 102 creates or receives data associated with a requested transaction. For example, in some embodiments, the requested transaction corresponds to a requested payment for medical services rendered, such as a medical provider (e.g., a hospital) requesting payment from a payer or intermediary (e.g., a health insurance provider). The requested transaction need not correspond to payments or medical service.

In some embodiments, the data comprises one or more data elements. For example, in the context of requested payments for medical services rendered, data elements may include a patient name or identifier, a provider name or identifier, a requested payment amount, one or more medical services rendered, and/or the like.

In some embodiments, the client application 102 generates a user interface 105 to be displayed to a user. For example, the interface may contain a plurality of data fields corresponding to the data elements. Using the generated interface, the user is able to input data associated with the requested transaction.

In some embodiments, the received data may be further processed and/or formatted by the client application 102. For example, the data may be formatted by the client application using the JSON format.

At 304, the data (hereinafter also referred to as the source data) is sent from the client application 102 to the mapping module 106. At 306, the mapping module, after receiving the source data from the client application, maps the source data to a standard format (e.g., the X12 standard). In some embodiments, the standard format used is based upon the type of transaction that the data is associated with. For example, in the context of health insurance and payments of medical services, the X12 standard may be used. Other types of transactions may make use of other types of standards.

In some embodiments, the source data may be checked prior to the mapping performed. This may comprise verifying that the source data contains one or more required data elements. For example, data corresponding to a professional claim may require a “diagnosis code” data element. If the received data does not contain a “diagnosis code” data element, then an error may be returned and the source data is not mapped.

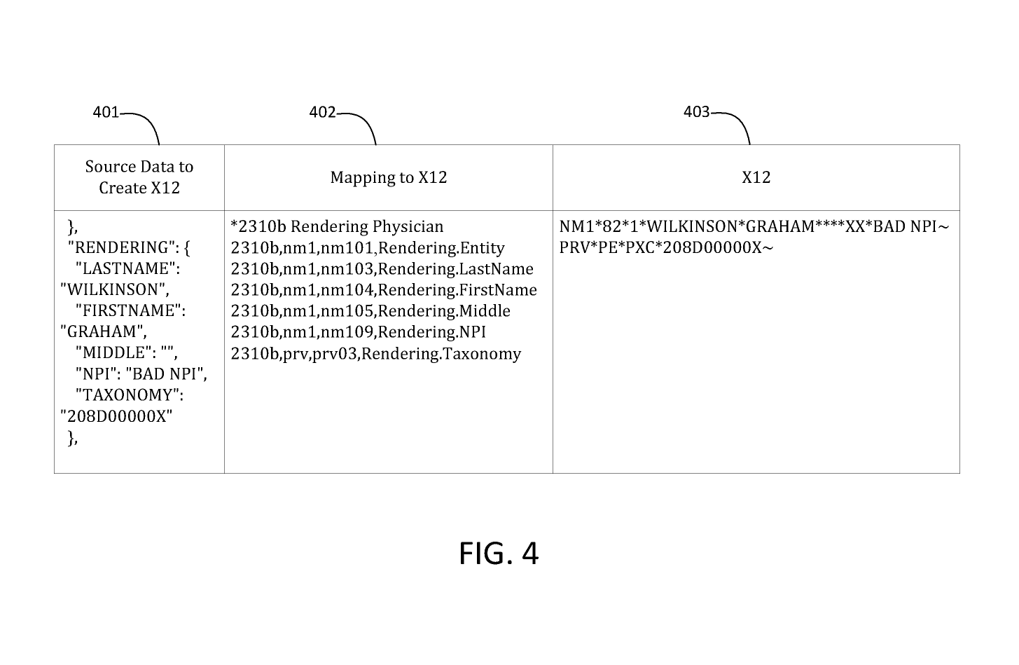

In some embodiments, the mapping is performed by retrieving a set of mappings (e.g., from mappings 107) that map data elements of the source data to data elements of the standard format being mapped to. For example, FIG. 4 illustrates a table showing one example mapping between received data and the X12 standard in accordance with some embodiments.

As illustrated in FIG. 4, column 401 of the table illustrates source data received from a client application. The source data may be formatted in the JSON format, and specify one or more data elements associated with a requested transaction. For example, the source data illustrated in FIG. 4 contains data elements corresponding to a provider of medical services (e.g., last name, first name, middle name, NPI, taxonomy).

Column 402 illustrates retrieved mappings that may be used to map the source data illustrated in column 401 to the X12 standard. The retrieved mappings specify how the various fields of the source data map to fields in the standard format. For example, the Rendering.LastName field of the source data is mapped to the 2310b,nml,nm103 field of the X12 standard, while the Rendering.LastName field is mapped to the 2310b,nml,nm104 field. Column 403 illustrates the resulting mapped data in the X12 standard after the mappings have been applied to the source data.

In some embodiments, the mappings may contain multiple sets of mappings. For example, a particular request processing application may be accessed by multiple, different client applications that generate source data in different formats. Mappings may be maintained for each of the source data formats to the specified standard.

In some embodiments, additional checks and/or validations may be performed on the data after it has been mapped. This may comprise checking the mapped data for any formatting and/or typographical errors. Particular data elements may have certain formatting requirements. For example, a “last name” data element may be required to contain a single word with no non-alphabetic characters, while a “social security number” data element may be required to contain nine numerical digits.

For example, in the mapping illustrated in FIG. 4, the value provided for the NPI data element in the source data (represented as “BAD NPI”), when mapped to the X12 standard, does not conform to the formatting requirements of the X12 standard for that data element, resulting in the detection of an error.

In some embodiments, at 308, a determination is made whether any errors were encountered during the mapping. If no error is detected, then at 310, the mapped data may be sent by the mapping module 106 to a request processing module 108. At 312, the mapped data may be subject to one or more checks or validations. The validation may be performed by the request processing module or an error detection module. In some embodiments, the mapped data is compared to previously stored data. For example, the mapped data may be validated against data retrieved from a database or data store containing previously stored data (e.g., patient data, provider data, and/or the like) to check for inconsistencies (e.g., if the patient name and social security number in the mapped data match those stored in the database). In other embodiments, various different types of checks, validations, or combinations thereof may be used to determine whether an error is present in the mapped data.

At 314, a determination is made whether an error was detected. If no error was detected, then at 316, the request specified by the mapped data is processed. For example, if the request pertains to a payment for medical services rendered, the request may be processed by transferring a requested payment amount to the requesting medical care provider. In some embodiments, an indication may be sent to the client application that indicating that the request has passed initial validations and is being processed.

However, if an error was detected (e.g., at 308 and/or 314), then at 318, source data associated with the error is identified using an error processing module 110. For example, if it is determined at 306 that the source data did not contain one or more required data elements (e.g., a “diagnosis code” data element for a professional claim request), the missing source data elements are identified.

On the other hand, in response to errors caused by one or more data elements of the mapped data having incorrect format or syntax (e.g., a social security number data element not having nine numerical digits), the source data elements may be identified by first identifying the mapped data elements associated with the error, and using the mappings in reverse to identify the source data elements that the mapped data elements were mapped from.

Similarly, for errors returned due to a failed check or validation of the mapped data (e.g. at 312), the mapped data elements associated with the error can be identified. For example, if the “patient name” and “birthday” data elements received in the mapped data is inconsistent with maintained records, an error may be returned identifying the mapped data elements associated with the error (“patient name” and “birthday”). From the identified mapped data elements, the corresponding source data elements can be identified.

At 320, the error processing module 110 transmits the error information to the client application 102. At 322, the received error information may be displayed to a user by the client application 102. In some embodiments, the user may view an interface 105 listing one or more errors that have been returned. By clicking on a displayed error, the user is displayed an interface allowing the user to change or enter revised information for the source data elements associated. In some embodiments, this interface may be the same interface or a similar interface to that used by the user to enter the original source data elements.

For example, when the user clicks on an error corresponding to a mismatch between patient name and birthday, the client application 102 may display a user interface that allows them to input or edit patient personal information. In some embodiments, the specific fields corresponding to the relevant source data elements may be highlighted or otherwise brought to the user's attention.

At 324, error correction information is received by the client application. This may comprise revised data elements entered by a user via the user interface 105 as described above. Once the error correction information has been received, the process may return to 304, where the revised source data to transmitted to the mapper 106.

Thus, by implementing the mapper 106 between the client application 102 and the request processing module 108, the user and the client application do not need to be aware of or possess an understanding of the standards (e.g., the X12 standard) used by the request processing module 108.

The standards used by the request processing application 103 may change over time, necessitating updates to the request processing application. However, in many cases while the structure or format of the data may change, the actual required data may remain the same. Because these updates are incorporated into the mapper 106, the client application 102 does not need to be aware of the changes to the standard. This allows for the user to continue using the same client application 102 without having to update the client application.

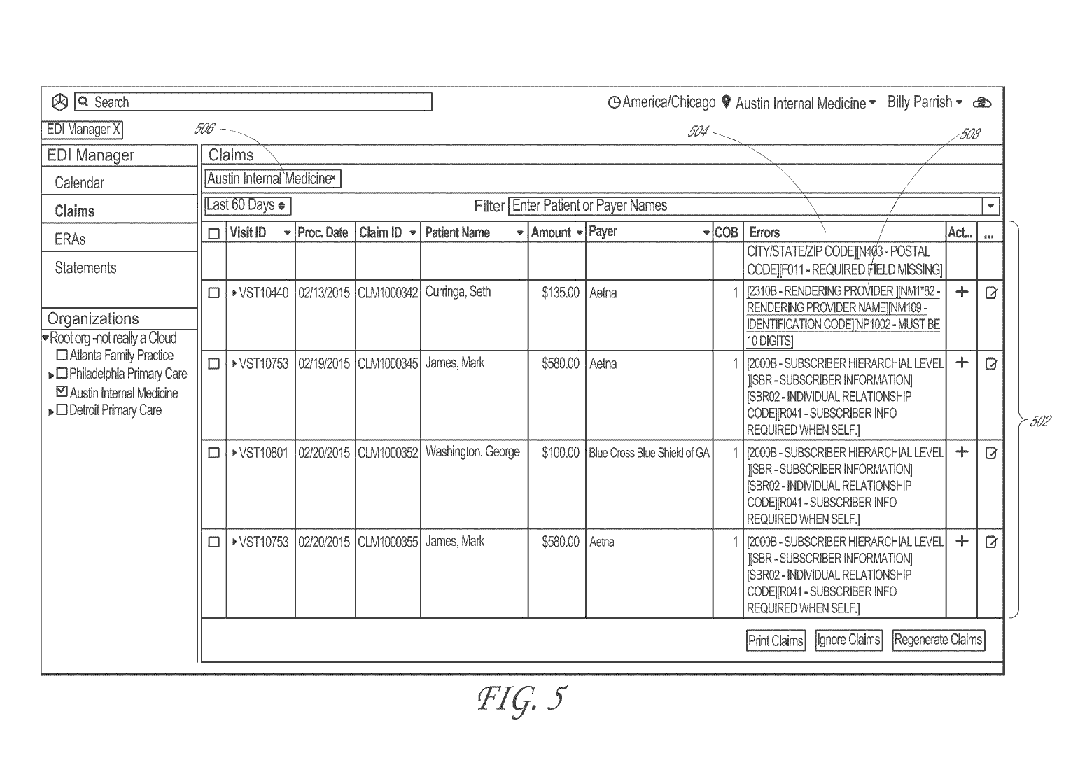

FIGS. 5-7 illustrate example interfaces that may be used for error correction in accordance with some embodiments. These interfaces may be included in the UI 105 of the client application 102 (FIG. 1). FIG. 5 illustrates an interface containing a table 502 showing errors returned by the request processing application 103. For example, in the illustrated embodiment, six errors corresponding to six requests are displayed in table 502. Table 502 may contain a plurality of columns containing data related to the request associated with the error, such as a visit identifier, a date of visit, patient name, claim number, claim amount, payer name, and/or the like. In addition, table 502 contains a column 504 containing error information. The error information may identify the particular source data element(s) associated with the error, as well as a type of error (e.g., incorrect syntax, invalid patient ID, missing field, and/or the like). In some embodiments, the error information may also contain identifiers of the mapped data elements associated with the error. This may be beneficial if the user of the client application 102 requires additional assistance with the error; for example, the data element identifiers may allow the user to communicate which data elements of the mapped data (which they may be familiar with) are associated with the error to personnel associated with the request processing application (who will typically be more familiar with the standard).

In some embodiments, the UI 105 may provide one or more controls allowing a user to configure the scope of the errors displayed. For example, one or more controls 506 may be used by the user to specify one or more filters. For example, controls 506 may include a filter allowing the user to specify a time period, such that only errors that occurred during the specified time period are displayed. Controls 506 may also include a filter that allowing the user to specify a particular provider (e.g., hospital), such that only errors associated with requests from the specified provider (e.g., “Austin Internal Medicine”) are displayed.

In some embodiments, the error information displayed in column 504 is displayed as a hyperlink. The error information may be displayed in a different color compared to the other data or have some other visual indication indicating that it is a hyperlink. In some embodiments, in response to a user highlighting or hovering over an error hyperlink 508, the error hyperlink 508 may change color or otherwise display some type of visual indication that it is being selected.

By clicking on error hyperlink 508, the user may be navigated to the source of the error. For example, the user may be presented with a user interface where the source data elements associated with the error can be edited. In some embodiments, the interface may be the same interface or a similar interface as the one used by the user to enter the initial source data.

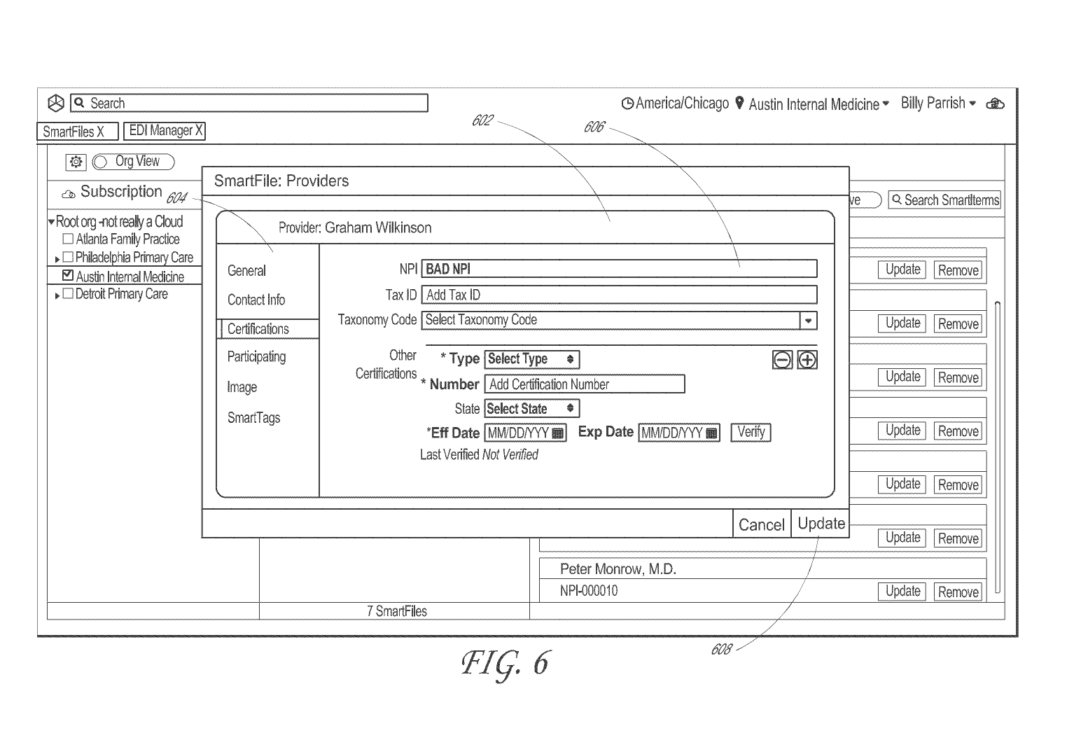

FIG. 6 illustrates an interface that may be displayed to a user in response to the user clicking on a hyperlink associated with a particular error, such as the error shown in FIG. 5. In some embodiments, the displayed interface may correspond to a data category associated with the source data specified in the error information. For example, the error indicated at 508 in FIG. 5 relates to the NPI data element associated with the medical provider “Graham Wilkinson.” Thus, an interface 602 that allows the user to specify or edit Graham Wilkinson's medical provider information is displayed. In some embodiments, interface 602 may be the original interface that the user used to enter provider information at the client application. Similarly, if the source data elements associated with an error related to information for a particular patient (e.g., an error relating to an incorrectly entered patient ID), the displayed interface may be an interface for specifying/editing information for that patient.

In some embodiments, an interface associated with a particular data category may comprise one or more subpages. For example, interface 602 may contain a sidebar 604 that lists the various subpages associated with the medical provider “Graham Wilkinson”. Each subpage may correspond to a different category of information (e.g., general information, contact information, information regarding the provider's certifications, and/or the like). In response to the user clicking on a hyperlink associated with an error, the client application 102 may display the specific interface subpage that contains the source data element associated with the error. For example, error 508 illustrated in FIG. 5 is associated with the NPI data element. Upon clicking on the hyperlink associated with the error, when the user may be presented with interface 602, the specific subpage of the medical provider interface from which the error originated (e.g., the subpage containing the interface field for specifying an NPI for the provider) may be automatically displayed.

The interface at 606 shows that the NPI previously received had a value of “BAD NPI.” The user is then able to enter in a new, valid value into the NPI field. The user may then click on an “update” button 608 to indicate completion of the edits to the source data. The revised source data may then be sent by the client application to the request processing application.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and tasks described herein may be performed and fully automated by a computer system. The computer system may, in some cases, include multiple distinct computers or computing devices (for example, physical servers, workstations, storage arrays, and so forth) that electronically communicate and interoperate over a network to perform the described functions. Each such computing device typically includes a processor (or multiple processors) that executes program instructions or modules stored in a memory or other computer-readable storage medium. Where the system includes multiple computing devices, these devices may, but need not, be co-located. The results of the disclosed methods and tasks may be persistently stored by transforming physical storage devices, such as solid state memory chips and/or magnetic disks, into a different state.

All of the methods and processes described above may be embodied in, and fully automated via, software code modules executed by one or more general purpose computers. The code modules may be stored in any type of non-transitory computer-readable medium or other computer storage device. Some or all of the methods may alternatively be embodied in specialized computer hardware. The results of the disclosed methods be stored in any type of computer data repository, such as relational databases and flat file systems that use magnetic disk storage and/or solid state RAM.

Many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer-implemented method for facilitating error correction in processing requests, comprising:
receiving, from a client application, source data associated with a request and comprising one or more data elements;
accessing a set of mappings, wherein the accessed mappings are based at least in part upon a specified standard;
using the accessed mappings, mapping the one or more data elements of the source data to produce mapped data that adheres to the specified standard;
determining whether an error is present in the mapped data; and
if a determination is made that an error is present:
identifying a data element of the mapped data associated with the error;
using the mappings, identifying a data element of the source data corresponding to the identified data element of the mapped data; and
returning error information to the client application, to be displayed to a user at the client application, wherein the error information comprises the identified data element of the source data;
if a determination is made that no error is present:
processing the mapped data to fulfill the request.

2. The method of claim 1, wherein determining whether an error is present comprises verifying that the one or more data elements of the source data contains at least one or more required data element types.

3. The method of claim 1, wherein determining whether an error is present comprises validating the mapped data against a database containing payment information.

4. The method of claim 1, wherein the request is associated with a payment pertaining to rendering of medical services.

5. The method of claim 4, wherein the one or more data elements of the source data comprise a physician name, a provider identifier, and one or more medical services rendered.

6. The method of claim 1, wherein the source data is in the JSON format. The method of claim 1, wherein the specified standard is the X12 standard.

8. The method of claim 1, further comprising:
receiving, from the client application, revised data associated with the request, based at least in part upon the returned error information.

9. The method of claim 1, further comprising:
in response to an update of the standard, updating the mappings to reflect the updated standard, without updating the client application or a format of data received from the client application.

10. The method of claim 1, wherein the error information returned to the client application is displayed to a user of the client application as a link, wherein the link links to a user interface comprises one or more interface elements allowing the user to change a value of the identified data element.

11. A system for processing requests, comprising:
a client application configured to generate source data associated with a request;
a mapping module, wherein the mapping module is configured to:
receive the source data from the client application;
access a set of mappings, wherein the accessed mappings are based at least in part upon a specified standard;
use the accessed mappings to map the one or more data elements of the source data to produce mapped data that adheres to the specified standard;
determine whether an error is present in the mapped data, wherein the mapping module is configured to, if a determination is made that an error is present:
identify a data element of the mapped data associated with the error;
using the mappings, identify a data element of the source data corresponding to the identified data element of the mapped data; and
return error information to the client application, wherein the error information comprises the identified data element of the source data; and
a request processing application configured to, if a determination is made that no error is present, process the mapped data to fulfill the request.

12. The system of claim 11, wherein determining whether an error is present comprises verifying that the one or more data elements of the source data contains at least one or more required data element types.

13. The system of claim 11, wherein determining whether an error is present comprises validating the mapped data against a database containing payment information.

14. The system of claim 11, wherein the request is associated with a payment pertaining to rendering of medical services.

15. The system of claim 14, wherein the one or more data elements of the source data comprise a physician name, a provider identifier, and one or more medical services rendered.

16. The system of claim 11, wherein the source data is in the JSON format.

17. The system of claim 11, wherein the specified standard is the X12 standard.

18. The system of claim 11, wherein the client application is further configured to, in response to receiving error information from the mapping module, generate or received revised data associated with the request, based at least in part upon the returned error information.

19. The system of claim 18, wherein the client application is configured to, in response to receiving error information from the mapping module, generate a user interface displaying the error information to a user.

20. The system of claim 11, wherein, in response to an update of the standard, the mappings are updated to reflect the updated standard, without updating the client application or a format of data received from the client application.
